(19) United States
(12) Patent Application Publication
(10) Pub. No.: US 2018/0352245 A1
(43) Pub. Date: Dec. 6, 2018

(54) METHODS AND APPARATUS FOR MULTI-ENCODER PROCESSING OF HIGH RESOLUTION CONTENT

(71) Applicant: GOPRO, INC., San Mateo, CA (US)

(72) Inventors: William Edward Macdonald, San Diego, CA (US); Daryl Stimm, Encinitas, CA (US); Peter Tran, San Diego, CA (US); Kyler William Schwartz, Valley Center, CA (US)

(21) Appl. No.: 15/982,945

(22) Filed: May 17, 2018

Related U.S. Application Data
(60) Provisional application No. 62/515,999, filed on Jun. 6, 2017.

(51) Int. Cl. H04N 19/463; H04N 19/33

(52) U.S. Cl. CPC H04N 19/463; H04N 19/33

(57) ABSTRACT

Methods and apparatus for multi-encoder processing of high resolution content. In one embodiment, the method includes capturing high resolution imaging content; splitting up the captured high resolution imaging content into respective portions; feeding the split up portions to respective imaging encoders; packing encoded content from the respective imaging encoders into an A/V container; and storing and/or transmitting the A/V container. In another embodiment, the method includes retrieving and/or receiving an A/V container; splitting up the retrieved and/or received A/V container into respective portions; feeding the split up portions to respective imaging decoders; stitching the decoded imaging portions into a common imaging portion; and storing and/or displaying at least a portion of the common imaging portion.

### PRIORITY

This application claims the benefit of priority to U.S. Provisional Patent Application Ser. No. 62/515,999 filed Jun. 6, 2017 of the same title, the contents of which being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the Disclosure

This disclosure relates to the encoding/decoding of high resolution content using extant video codecs.

### Description of Related Art

Imaging sensors, such as imaging sensors contained within image capture devices such as the GoPro Hero™ family of devices manufactured by the Assignee hereof, may natively capture imaging content (e.g., still images, video content, panoramic content) at a resolution and frame rate that is incompatible with many extant imaging codecs contained within many common computing devices (such as smart phones). Accordingly, many types of captured imaging content may not be processed at their natively captured resolutions and/or at their natively captured bit rates (e.g., frame rates). Accordingly, what is needed are methodologies and apparatus that enable the processing of high resolution imaging content at native resolutions and native bit rates using extant imaging codecs that are not well suited for these native resolutions and native bit rates.

### SUMMARY

The present disclosure satisfies the foregoing needs by providing, inter alia, methods and apparatus for enabling the processing of high resolution imaging content.

In one aspect, a method for storing and/or transmitting high resolution imaging content is disclosed. In one embodiment, the method includes: capturing high resolution imaging content; splitting up the captured high resolution imaging content into respective portions; feeding the split up portions to respective imaging encoders; packing encoded content from the respective imaging encoders into an A/V container; and storing and/or transmitting the A/V container.

In one variant, the method further includes inserting metadata into at least one of the split up portions, the metadata including one or more of timestamp information, original resolution for the captured high resolution imaging content, original bit rate for the captured high resolution imaging content, and manner in which the captured high resolution imaging content was split.

In another variant, the splitting up of the captured high resolution imaging content includes splitting the captured high resolution imaging content into two or more equally sized portions.

In yet another variant, the splitting up of the captured high resolution imaging content includes splitting the captured high resolution imaging content into two or more asymmetrically sized portions.

In yet another variant, the splitting up of the captured high resolution imaging content includes splitting the captured high resolution imaging content into two or more portions such that at least two of the two or more portions includes overlapping imaging content.

In yet another variant, the packing of the encoded content from the respective imaging encoders into the A/V container includes inserting the encoded content into separate tracks of the A/V container.

In yet another variant, the method further includes inserting a lower resolution version of the high resolution imaging content into a separate track of the A/V container.

In another aspect, a method for storing and/or displaying high resolution imaging content is disclosed. In one embodiment, the method includes: retrieving and/or receiving an A/V container; splitting up the retrieved and/or received A/V container into respective portions; feeding the split up portions to respective imaging decoders; combining the decoded imaging portions into a common imaging portion; and storing and/or displaying at least a portion of the common imaging portion.

In one variant, the combining of the decoded imaging portions into the common imaging portion includes stitching of the decoded imaging portions.

In another variant, the stitching of the decoded imaging portions includes utilizing pixel alignment in a graphics processing unit (GPU) fragment shader.

In yet another variant, the method further includes reading metadata information from the retrieved and/or received A/V container, the read metadata information being utilized for the combining.

In yet another variant, the method further includes translating the common imaging portion to a smaller imaging resolution.

In yet another variant, the translating of the common imaging portion to the smaller imaging resolution occurs prior to the displaying of at least the portion of the common imaging portion.

In yet another variant, the A/V container includes a multi-track A/V container and the method further includes reading a low resolution version of the common imaging portion, the low resolution version having a resolution that is lower than a native version of the common imaging portion.

In yet another aspect, a non-transitory computer readable apparatus is disclosed. In one embodiment, the non-transitory computer readable apparatus includes a storage medium having computer-readable instructions stored thereon, the computer-readable instructions being configured to, when executed by one or more processing units: receive high resolution imaging content; split up the received high resolution imaging content into respective portions; transmit the split up portions to respective imaging encoders; pack encoded content from the respective imaging encoders into an A/V container; and store and/or transmit the A/V container.

In one variant, the high resolution imaging content includes panoramic imaging content and the respective portions of the split up high resolution imaging content includes an area of expected interest portion and an area of non-expected interest portion.

In another variant, the A/V container includes a multiple track A/V container and the encoded content packed into the multiple track A/V container includes a first of the respective portions being packed into a first track of the multiple track A/V container and a second of the respective portions being packed into a second track of the multiple track A/V container.

In yet another variant, the computer-readable instructions being further configured to, when executed by the one or more processing units: insert metadata into at least one of the first track and the second track.

In yet another variant, the inserted metadata includes one or more of timestamp information, original resolution for the received high resolution imaging content, original bit rate for the received high resolution imaging content, and manner in which the received high resolution imaging content was split.

In yet another variant, the computer-readable instructions being further configured to, when executed by the one or more processing units: insert a low resolution version of the received high resolution imaging content into a third track of the multiple track A/V container.

In yet another aspect, a system for the capture and encoding of high resolution imaging content is disclosed. In one embodiment, the system includes an image capture device, an image splitter coupled with the image capture device, two or more encoders coupled with the image splitter, an output of the two or more encoders configured to generate an A/V container.

In yet another aspect, a system for the rendering of high resolution imaging content is disclosed. In one embodiment, the system includes an A/V container splitter configured to receive an A/V container, two or more decoders coupled with the A/V container, and a stitching apparatus that is coupled with an output of the two or more decoders.

In yet another aspect, an integrated circuit apparatus is disclosed. In one embodiment, the integrated circuit apparatus is configured to perform one or more portions of the aforementioned methodologies.

Other aspects, features and advantages of the present disclosure will immediately be recognized by persons of ordinary skill in the art with reference to the attached drawings and detailed description of exemplary embodiments as given below.

### BRIEF DESCRIPTION OF THE DRAWINGS

The disclosed embodiments have other advantages and features which will be more readily apparent from the following detailed description of the invention and the appended claims, when taken in conjunction with the accompanying drawings, in which:

FIG. 1A illustrates a system for the capture and encoding of high resolution imaging content in accordance with some implementations.

FIG. 1B illustrates a system for rendering high resolution imaging content received from the system of FIG. 1A in accordance with some implementations.

FIGS. 2A-2C illustrate various ways for image splitting high resolution imaging content in accordance with some implementations.

FIG. 3A is a flow chart illustrating a process for the capture and encoding of high resolution imaging content in accordance with some implementations.

FIG. 3B is a flow chart illustrating a process for rendering high resolution imaging content in accordance with some implementations.

All Figures disclosed herein are © Copyright 2018 GoPro, Inc. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations, but other implementations are possible by way of interchange of, substitution of, or combination with some or all of the described or illustrated elements. Wherever convenient, the same reference numbers will be used throughout the drawings to refer to same or like parts.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Exemplary Capture and Rendering Systems for High Resolution Imaging Content

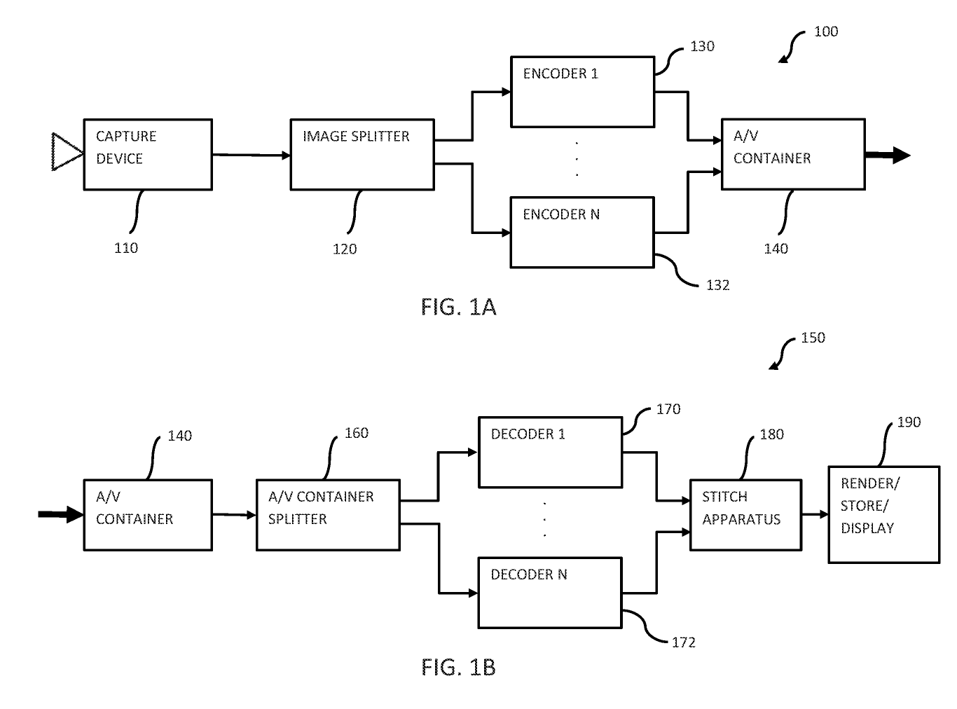

Referring now to FIG. 1A, an exemplary system 100 for the capture and encoding of high resolution imaging content is shown. As used herein, the terms “high resolution” and “high resolution imaging content” refers to the fact that, for example, natively captured imaging content (e.g., still images, video content, stereoscopic, and/or panoramic versions of the foregoing) may not be compatible with a single instance of, for example, extant video encoders/decoders (e.g., codecs). For example, common smartphone device codecs are typically limited to 2K image resolution at sixty (60) frames per second or 3K image resolution at thirty (30) frames per second. However, it is not uncommon for image capture devices to natively capture imaging content at higher resolutions and higher frame rates than are currently supported by many single instances of these extant video codecs. For example, and referring back to FIG. 1A, the image capture device 110 (e.g., camera) may be capable of generating, for example, 4K image resolution at sixty (60) frames per second or 6K image resolution at thirty (30) frames per second. While the aforementioned image resolutions and frame rates are exemplary, it would be readily apparent to one of ordinary skill given the contents of the present disclosure that the present disclosure is not so limited, these aforementioned image resolutions and frame rates merely being exemplary.

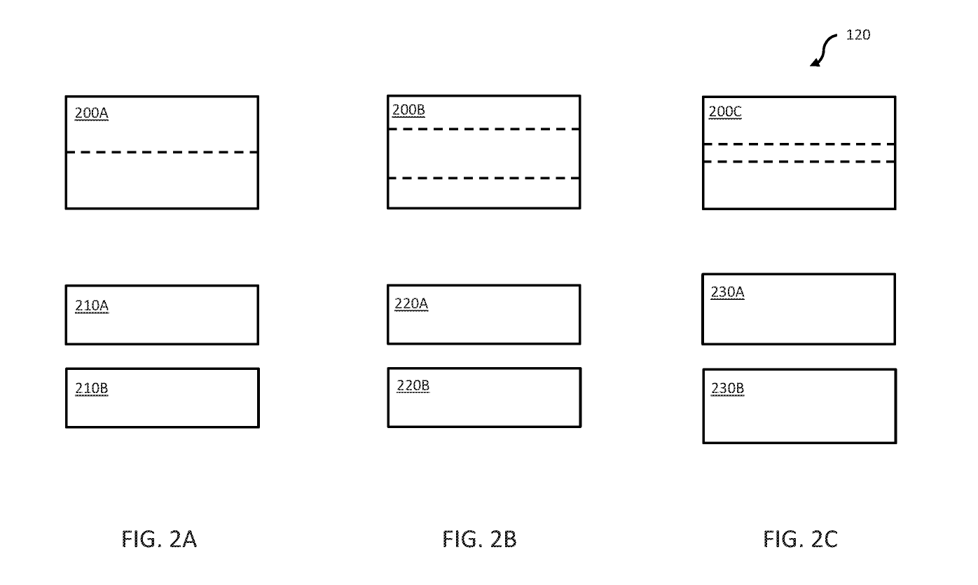

The captured imaging content (e.g., natively captured imaging content) may be coupled to an image splitter 120 on the encode-side of the capture side of the processing pipeline. For example, the image splitter 120 may be resident on the image capture device 110 in some implementations. The image splitter 120 may be in signal communication with the image capture device 110 via either a wired or wireless network communications link. The image splitter 120 may split up the captured imaging content and pass along this split up captured imaging content to a series of N encoders 130, 132. For example, where the value of N is equal to two, the captured imaging content may be bi-sected into two imaging portions of either identical or asymmetric size. In some implementations, the captured imaging content may be split up so that a portion of the imaging content is shared between two (or more) of the split up frames. These and other variants will be discussed in subsequent detail herein with regards to the discussion of FIGS. 2A-2C discussed infra.

The split up imaging content may then be fed to various respective encoders (e.g., ‘encoder 1’ 130, ‘encoder N’ 132, and/or other encoders). For example, in some implementations, the encoders may include H.264 video encoders and the number of encoder instances is two. As a brief aside, many common computing devices may support one or more types of encoders/decoders (such as H.265/MPEG-H HEVC; H.264/MPEG-4 AVC; H.263/MPEG-4 Part 2; H.262/MPEG-2; Microsoft® encoders; Google® encoders and/or various other types of encoders). However, it has been found by the Assignee of the present application that although many of these types of encoders/decoders have limitations with regards to resolution and bit rate, often times these common computing devices may support multiple instances of the same encoder/decoder. In other words, these common computing devices may be “tricked” into encoding/decoding respective portions of, for example, natively captured video content of a higher resolution and/or a higher bit rate, such that each of these respective portions complies with the encoding parameter constraints associated with the underlying codecs supported by these computing devices.

The output of these encoders 130, 132 may be coupled and fed into one or more audio/visual (A/V) containers 140. For example, the A/V container 140 may include an MP4 container format and the multiple instances output from respective encoders 130, 132 may be stored within respective tracks contained within a single MP4 container. In some implementations, the output from respective encoders 130, 132 may be fed into two or more MP4 containers (e.g., into single track MP4 containers, into multiple dual track MP4 containers, and/or into multiple multi-track MP4 containers, etc.). These A/V container(s) 140 may then be transmitted and stored into a storage apparatus (e.g., a hard drive or other types of memory) and/or may be transmitted across an interface (such as a network interface over, for example, the Internet). One or more of these A/V container(s) may also include respective metadata which may be utilized in order to, inter alia, facilitate rendering of the high resolution imaging content which is described at, for example, FIG. 1B. The aforementioned image splitter 120, encoders 130, 132, and A/V container 140 may be implemented through the use of a computer program containing computer-readable instructions that may be executed by one or more processing units. These computer-readable instructions may be stored in a computer-readable apparatus (e.g., memory). In some implementations, one or more of the aforementioned image splitter 120, encoders 130, 132, and A/V container 140 may be implemented through dedicated hardware components (e.g., one or more integrated circuits).

Referring now to FIG. 1B, a system 150 for the rendering of high resolution imaging content is shown and described in detail. The A/V container(s) 140, such as the A/V container(s) output from system 100, may be received/retrieved by system 150. These A/V container(s) 140 may be coupled to a A/V container splitter (decode-side) 160. In some implementations, the A/V container splitter 160 may be embodied within the Quik™ software/computer program application manufactured by the Assignee hereof. In some implementations, the A/V container splitter 160 may read metadata information contained within the A/V container(s) 140 so as to enable the A/V container splitter 160 to, for example, open up the required number of instances of the decoders 170, 172 as well as to properly partition out the imaging portions contained within the A/V container(s) 140 so that these imaging portions may be properly decoded. In some implementations, the opening of additional instances of the decoders may be performed without the underlying knowledge of the user such that the encoding/decoding of this high resolution imaging content may occur seamlessly.

In some implementations, the metadata may include timestamp information for respective imaging portions so as to enable these imaging portions to be recognized and recombined appropriately by, for example, stitch apparatus 180. Respective imaging portions may be fed to a corresponding decoder instance 170, 172. For example, in the context of a two-track MP4 container, track one may be fed to decoder 170, while track two may be fed to decoder 172. In some implementations, the metadata may also/alternatively include a simple integer frame counter (e.g., a monotonically increasing integer frame counter) for linking two or more portions of the split up image. These and other variants would be readily apparent to one of ordinary skill given the contents of the present disclosure.

The output of decoders 170, 172 may be fed to a stitch apparatus 180. The stitch apparatus 180 may recombine the decoded image portions from the decoders 170, 172. In some implementations, the stitching algorithm for the stitch apparatus 180 may be simplified and may recombine the decoded image portions based on metadata information contained within the A/V container(s) 140. For example, the stitching may be performed by a fragment shader by reorienting the decoded image portions. Accordingly, as the decoded image portions may be perfectly “cut”, no higher level “stitching” is required, rather the decoded image portions may be aligned via pixel alignment in, for example, a graphic processing units' (GPU) fragment shader. In this manner, stitching operations from the stitch apparatus 180 may be substantially simplified allowing for, for example, the recombined decoded images to be output in real-time (or near real-time) to the render/store/display apparatus 190. The render/store/display apparatus 190 may, for example, pass on the entirety of the decoded image to a storage apparatus (e.g., a hard drive or other types of memory) where the entirety of the decoded image is displayed to a user. In some implementations, the render/store/display apparatus 190 may render the entirety of the decoded image and may re-render the entirety of the decoded image to a smaller resolution if desired (e.g., for display on a display device). The aforementioned A/V container 140, A/V container splitter 160, decoders 170, 172 and stitch apparatus 180 may be implemented through the use of a computer program containing computer-readable instructions that may be executed by one or more processing units. These computer-readable instructions may be stored in a computer-readable apparatus (e.g., memory). In some implementations, one or more of the aforementioned A/V container 140, A/V container splitter 160, decoders 170, 172 and stitch apparatus 180 may be implemented through dedicated hardware components (e.g., one or more integrated circuits).

Referring now to FIGS. 2A-2C, various methodologies for the splitting up of images captured by capture device 110 using the image splitter on the encode-side 120 are shown and described in detail. For example, and referring now to FIG. 2A, the captured image 200A may be bisected into, for example, top 210A and bottom portions 210B. Additionally, as the encoders may be capable of handling higher resolutions and higher bit rates than that contained within each of the top 210A and bottom portions 210 by themselves, additional metadata may be inserted into one or both of these imaging portions. This metadata may include, for example, the aforementioned timestamp information so as to link the top and bottom portions in time for later recombination. This metadata may also include, for example, one or more of the original resolution and bit rates (e.g., 4K resolution at sixty (60) frames per second), the manner in which the original image has been split (e.g., top and bottom) as well as where the imaging portions 210A, 210B reside within the original image (e.g., imaging portion 210A resides at the top of the original image while imaging portion 210B resides at the bottom of the original image, etc.).

Moreover, while primarily described in the context of splitting up an original image into two equally sized respective imaging portions, it would be readily apparent to one of ordinary skill given the contents of the present disclosure that an original image 200A may be split into asymmetric imaging portions (e.g., top imaging portion 210A may be larger in image size than bottom imaging portion 210B) or may even be split into three or more imaging portions (e.g., top, middle, and bottom imaging portions). The use of asymmetric imaging portion splits may be particularly suitable for, for example, the insertion of text onto a portion of the split up portions; the application of various post-processing applications (e.g., application of a contrast operation to one or more (but not all)) of the imaging portions; the insertion of telemetry information for objects contained within an imaging portion; for purposes of localized object detection, and other suitable techniques that would be readily apparent to one of ordinary skill given the contents of the present disclosure. Moreover, in some implementations it may be desirable to split up these imaging portions into left and right imaging portions; or left, middle, and right imaging portions in some implementations.

In some implementations, it may be desired to include a lower resolution version (LRV) of the high resolution image as, for example, a separate track (e.g., track one) within the A/V container that also contains separate track(s) (e.g., tracks two and three) of the high resolution version of the imaging data. The LRV of the high resolution image may also be stored within a separate A/V container. In implementations in which the LRV is stored separately, metadata may be stored in the LRV A/V container, and/or within the high resolution A/V container so that these separate containers may be, for example, readily linked. In some implementations, the inclusion of the LRV of the high resolution image may have utility for a full screen preview of the underlying captured image in instances where some players (codecs) have an inability to decode the high resolution images (e.g., the high resolution images contained within tracks two and three).

Referring now to FIG. 2B, yet another methodology for the splitting up of an original image 200B is shown and described in detail. For example, the image may be split up between an area of expected interest (e.g., between the two dashed lines in original image 200B). This area of expected interest may be split into imaging portion 220A, while the imaging portions above and below these dashed lines in original image 200B may be split into imaging portion 220B. For example, in the context of panoramic imaging content captured by image capture device 110, the area of expected interest may reside along the equator and may include, for example, the front, left, and right views of an image; while the area of least expected interest may reside at the poles (e.g., up and down views). In some implementations, various ones of the implementations described with respect to FIG. 2A may be utilized in conjunction with the image splitting methodology described in FIG. 2B (e.g., asymmetric splits, three or more splits, left and right splits, etc.). For example, the expected area of interest may constitute 60% of the total imaging area and stored within a first track of an A/V container, while, for example, the top 20% and bottom 20% of the total imaging area may be stored within a second track of the same A/V container.

Referring now to FIG. 2C, yet another methodology for splitting up an original image 200C is shown and described in detail. For example, image 200C may include an overlap region where identical (or near identical) imaging content is displayed in both of the split images 230A and 230B. For example, the area of overlap may include one to ten percent (1%-10%) of the total image area. Such an implementation as illustrated in FIG. 2C may improve upon the encoding efficiency associated with the encoding of individual imaging portion 230A and individual imaging portion 230B. For example, motion estimation information may now be included in the overlap regions contained within both image portion 230A and image portion 230B. The encoding efficiency of image portion 230A and 230B may be improved over variants in which there is no overlap in imaging content (such as that shown in implementations of FIGS. 2A and 2B). In some implementations, various ones of the implementations described with respect to FIGS. 2A and 2B may be utilized in conjunction with the image splitting methodology described in FIG. 2C (e.g., asymmetric splits, three or more splits, left and right splits, etc.).

### Exemplary Methodologies

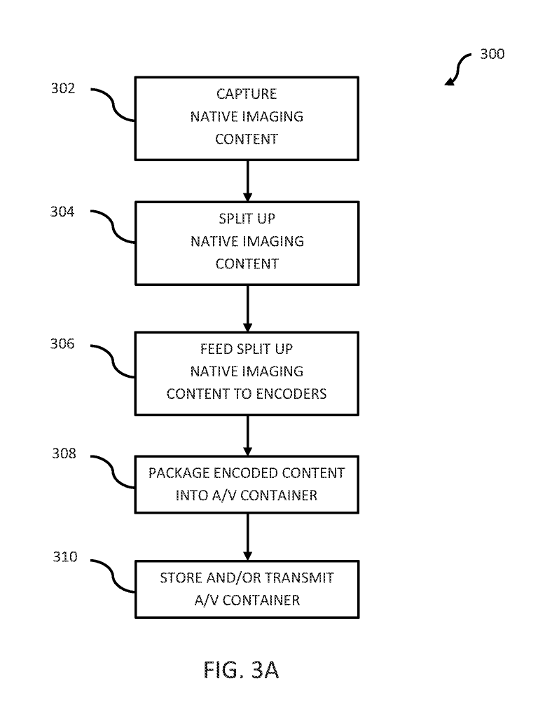

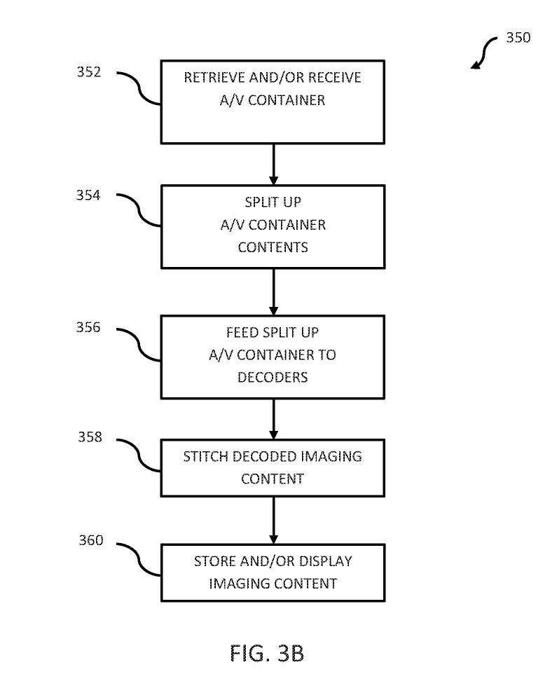

Referring now to FIG. 3A, one exemplary process 300 for the capture and encoding of high resolution imaging content is shown and described in detail. At operation 302, imaging content (such as native imaging content) is captured. In some implementations, the imaging content captured may include video content (e.g., panoramic imaging content) that is captured at a higher resolution than is supported by many extant imaging codecs. For example, the imaging content captured may include imaging content captured at 6K image resolution at thirty (30) frames per second. As but yet another example, the imaging content captured may include imaging content captured may include imaging content captured at 4K image resolution at sixty (60) frames per second.

At operation 304, the imaging content captured may be split up. In some implementations, the imaging content may be split up using one or more of the methodologies described herein with reference to FIGS. 2A-2C. In some variants, the split up imaging content may include metadata that enables the split up of imaging content to be reconstructed at operation 358 (FIG. 3B).

At operation 306, the split up imaging content may be fed to respective instances of an imaging encoder. For example, the imaging content captured at operation 302 may not be compatible with an extant single instance of an encoder; however, by virtue of the fact that the imaging content has been split up at operation 304, multiple instances of encoders (e.g., encoders 130, 132 in FIG. 1A) may now collectively be compatible with respective imaging portions.

At operation 308, the encoded content may be packaged into one or more A/V containers. For example, in some implementations, the encoded content may be packaged within separate tracks of a single A/V container (e.g., an MP4 container). In some implementations, the encoded portions of content may be packaged within separate A/V containers (e.g., separate MP4 containers). For example, the imaging content captured at operation 302 may include 6K resolution video content captured at thirty (30) frames per second. This captured imaging content may then be packaged into separate tracks for a given A/V container, each track including, for example, 3K resolution video content packaged at thirty (30) frames per second. As but another example, the imaging content captured at operation 302 may include 4K resolution video content captured at sixty (60) frames per second and the captured imaging content may be packaged into separate tracks for a given A/V container, each track including 2K resolution video content packaged at sixty (60) frames per second. These and other variations would be readily apparent to one of ordinary skill given the contents of the present disclosure. At operation 310, this packaged encoded A/V container content may be stored and/or transmitted.

Referring now to FIG. 3B, one exemplary process 350 for rendering high resolution imaging content is shown and described in detail. At operation 352, A/V container(s), such as A/V containers stored and/or transmitted at operation 310 (FIG. 3A), are retrieved and/or received.

At operation 354, the A/V container(s) are split up prior to being decoded at operation 356. In some implementations, one or more of the A/V container(s) may include metadata which instructs the methodology by which the A/V container(s) are to be split up.

At operation 356, the split up A/V container(s) are fed to respective ones of imaging decoders. For example, the imaging content captured at operation 302 may include 6K resolution video content captured at thirty (30) frames per second. This captured imaging content may be packaged into separate tracks for a given A/V container, each track including 3K resolution video content packaged at thirty (30) frames per second. Accordingly, each track including 3K resolution video content packaged at thirty (30) frames per second may be decoded at operation 356.

As but another example, the imaging content captured at operation 302 may include 4K resolution video content captured at sixty (60) frames per second and the captured imaging content may be packaged into separate tracks for a given A/V container, each track including 2K resolution video content packaged at sixty (60) frames per second. Accordingly, each track including 2K resolution video content packaged at sixty (60) frames per second may be decoded at operation 356. These and other variations would be readily apparent to one of ordinary skill given the contents of the present disclosure.

At operation 358, the decoded imaging content may be stitched together so as to recombine the decoded imaging content into, for example, the original captured content at the native resolution and the native bit rate. In some implementations, the stitching operation at 358 may utilize pixel alignment in a GPU fragment shader.

At operation 360, the stitched decoded imaging content from operation 358 may be stored in a storage apparatus (e.g., a hard drive or other types of memory). In some implementations, the stitched decoded imaging content from operation 358 may be displayed on a user's display device. The stitched decoded imaging content from operation 358 may be translated to a smaller resolution, if desired, for display to a user's display device.

### Additional Configuration Considerations

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements that are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the term “computing device”, includes, but is not limited to, personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans), Binary Runtime Environment (e.g., BREW), and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the terms “camera” or “image capture device” may be used to refer without limitation to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A method for storing and/or transmitting high resolution imaging content, the method comprising:
capturing high resolution imaging content;
splitting up the captured high resolution imaging content into respective portions;
feeding the split up portions to respective imaging encoders;
packing encoded content from the respective imaging encoders into an A/V container; and
storing and/or transmitting the A/V container.

2. The method of claim 1, further comprising inserting metadata into at least one of the split up portions, the metadata including one or more of timestamp information, original resolution for the captured high resolution imaging content, original bit rate for the captured high resolution imaging content, and manner in which the captured high resolution imaging content was split.

3. The method of claim 2, wherein the splitting up of the captured high resolution imaging content comprises splitting the captured high resolution imaging content into two or more equally sized portions.

4. The method of claim 2, wherein the splitting up of the captured high resolution imaging content comprises splitting the captured high resolution imaging content into two or more asymmetrically sized portions.

5. The method of claim 2, wherein the splitting up of the captured high resolution imaging content comprises splitting the captured high resolution imaging content into two or more portions such that at least two of the two or more portions includes overlapping imaging content.

6. The method of claim 1, wherein the packing of the encoded content from the respective imaging encoders into the A/V container comprises inserting the encoded content into separate tracks of the A/V container.

7. The method of claim 6, further comprising inserting a lower resolution version of the high resolution imaging content into a separate track of the A/V container.

8. A non-transitory computer readable apparatus comprising a storage medium having computer-readable instructions stored thereon, the computer-readable instructions being configured to, when executed by one or more processing units:
receive high resolution imaging content;
split up the received high resolution imaging content into respective portions;
transmit the split up portions to respective imaging encoders;
pack encoded content from the respective imaging encoders into an A/V container; and
store and/or transmit the A/V container.

9. The non-transitory computer readable apparatus of claim 8, wherein the high resolution imaging content comprises panoramic imaging content and the respective portions of the split up high resolution imaging content includes an area of expected interest portion and an area of non-expected interest portion.

10. The non-transitory computer readable apparatus of claim 8, wherein the A/V container comprises a multiple track A/V container and the encoded content packed into the multiple track A/V container includes a first of the respective portions being packed into a first track of the multiple track A/V container and a second of the respective portions being packed into a second track of the multiple track A/V container.

11. The non-transitory computer readable apparatus of claim 10, wherein the computer-readable instructions being further configured to, when executed by the one or more processing units:
insert metadata into at least one of the first track and the second track.

12. The non-transitory computer readable apparatus of claim 11, wherein the inserted metadata includes one or more of timestamp information, original resolution for the received high resolution imaging content, original bit rate for the received high resolution imaging content, and manner in which the received high resolution imaging content was split.

13. The non-transitory computer readable apparatus of claim 10, wherein the computer-readable instructions being further configured to, when executed by the one or more processing units:
insert a low resolution version of the received high resolution imaging content into a third track of the multiple track A/V container.

14. A method for storing and/or displaying high resolution imaging content, the method comprising:
retrieving and/or receiving an A/V container;
splitting up the retrieved and/or received A/V container into respective portions;
feeding the split up portions to respective imaging decoders;
combining the decoded imaging portions into a common imaging portion; and
storing and/or displaying at least a portion of the common imaging portion.

15. The method of claim 14, wherein the combining of the decoded imaging portions into the common imaging portion comprises stitching of the decoded imaging portions.

16. The method of claim 15, wherein the stitching of the decoded imaging portions comprises utilizing pixel alignment in a graphics processing unit (GPU) fragment shader.

17. The method of claim 14, further comprising reading metadata information from the retrieved and/or received A/V container, the read metadata information being utilized for the combining.

18. The method of claim 14, further comprising translating the common imaging portion to a smaller imaging resolution.

19. The method of claim 18, wherein the translating of the common imaging portion to the smaller imaging resolution occurs prior to the displaying of at least the portion of the common imaging portion.

20. The method of claim 14, wherein the A/V container comprises a multi-track A/V container and the method further includes reading a low resolution version of the common imaging portion, the low resolution version having a resolution that is lower than a native version of the common imaging portion.
